(19) United States
(12) Patent Application Publication
(10) Pub. No.: US 2009/0296314 A1
(43) Pub. Date: Dec. 3, 2009

(54) CAPACITOR OF SEMICONDUCTOR DEVICE AND MANUFACTURING METHOD THEREOF

(76) Inventor: Taek-Seung Yang, Yeoju-gun (KR)

Correspondence Address: SHERR & VAUGHN, PLLC, 620 HERNDON PARKWAY, SUITE 320, HERNDON, VA, 20170, US

(21) Appl. No.: 12/474,034

(22) Filed: May 28, 2009

(30) Foreign Application Priority Data
Jun. 3, 2008 (KR) 10-2008-0052074

(51) Int. Cl. H01G 4/06; B05D 5/12

(52) U.S. Cl. 361/313; 427/79

(57) ABSTRACT

Embodiments relate to a capacitor in a semiconductor device having high capacitance and a manufacturing method thereof. The capacitor includes a bottom electrode over a substrate, a dielectric layer stacked over the bottom electrode and including a first dielectric layer having a thickness of about 30 Å±2 Å, a second dielectric layer having a thickness of about 100 Å±5 Å, and a third dielectric layer having a thickness of about 30 Å±2 Å, and a top electrode over the dielectric layer. Since dielectric layers having great band gaps are deposited over and under the top and bottom of the dielectric layer having a small band gap, the electric stability and leakage current characteristic are improved. The capacitor may have a high capacitance of 8 fF or above, and may be used for semiconductor devices, for example in development of high technology DRAM and CMOS devices.

The present application claims priority under 35 U.S.C. 119 to Korean Patent Application No. 10-2008-0052074 (filed on Jun. 3, 2008), which is hereby incorporated by reference in its entirety.

### BACKGROUND

Semiconductor integrated circuits have been used in various industries. An analog capacitor formed in a logic circuit area within an integrated circuit needs to operate at high speed and have a large capacitance. To obtain a high-speed capacitor, the resistance of an electrode of the capacitor must be reduced such that frequency dependent characteristics can be minimized. In addition, to obtain a capacitor having large capacitance, the thickness of a capacitor dielectric layer must be reduced. Otherwise, a high-K dielectric layer will be required or the capacitor area will need to be increased.

In general, if a capacitor having a large capacitance has a PIP (Polysilicon-Insulator-Polysilicon) structure, conductive polysilicon is used for a top electrode and a bottom electrode. An oxidation reaction occurs at an interfacial surface between the top and bottom electrodes and an insulating layer. Thus, a natural oxide layer is formed, so that the capacitance may be reduced.

To solve the above problem, a capacitor having a MIM (Metal-Insulator-Metal) structure has been suggested. The MIM capacitor has low specific resistance without parasitic capacitance caused by depletion, so the MIM capacitor is mainly used in high-performance semiconductor devices that require high Q values.

### SUMMARY

Embodiments relate to a capacitor with a high capacitance in a semiconductor device and a manufacturing method thereof. According to embodiments, a capacitor of a semiconductor device includes a bottom electrode over a substrate, a dielectric layer stacked over the bottom electrode and including a first dielectric layer having a thickness of about 30 Å±2 Å, a second dielectric layer having a thickness of about 100 Å±5 Å, and a third dielectric layer having a thickness of about 30 Å±2 Å, and a top electrode over the dielectric layer.

According to embodiments, a method for manufacturing a capacitor of a semiconductor device includes forming a bottom electrode over a substrate, forming a first dielectric layer having a thickness of about 30 Å±2 Å over the bottom electrode, forming a second dielectric layer having a thickness of about 100 Å±5 Å over the first dielectric layer, forming a third dielectric layer having a thickness of about 30 Å±2 Å over the second dielectric layer, and forming a top electrode over the third dielectric layer.

Embodiments provide a capacitor of a semiconductor device having high capacitance, for example, 8 fF/μm² or above. Embodiments provide a method for manufacturing a capacitor of a semiconductor device having a dielectric layer formed by stacking high-K dielectric materials such that the capacitor has high capacitance.

### DRAWINGS

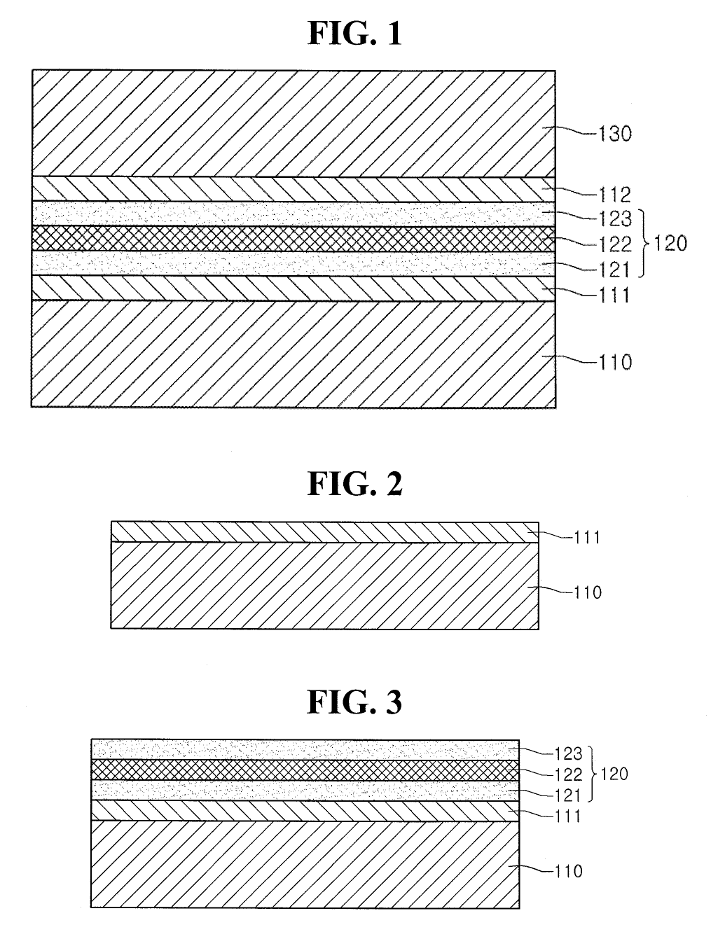

Example FIG. 1 is a sectional view showing a capacitor of a semiconductor device according to embodiments.

Example FIGS. 2 to 4 are sectional views showing the manufacturing procedure for a capacitor of a semiconductor device according to embodiments.

Example FIG. 5 is a chart showing characteristic values of a capacitor according to embodiments.

### DESCRIPTION

Example FIG. 1 is a sectional view showing a capacitor of a semiconductor device according to embodiments. Referring to example FIG. 1, a barrier metal layer 111 is stacked over a bottom electrode 110, a dielectric layer 120 is formed over the barrier metal layer 111, a second barrier metal layer 112 is stacked over the dielectric layer 120, and a top electrode is formed over barrier metal layer 112.

The bottom and top electrodes 110 and 130 may include copper metal layers. If the bottom and top electrodes 110 and 130 include copper metal layers, the copper metal layer can be formed through a damascene process. According to the damascene process, an insulating layer is partially etched through a photo-etch process to form a trench, and a copper seed layer is deposited over the insulating layer such that the trench is filled with the copper seed layer. Then, the copper seed layer is planarized through a chemical mechanical polishing process, thereby forming a copper interconnection.

In addition, the bottom and top electrodes 110 and 130 may include aluminum metal layers. If the bottom and top electrodes 110 and 130 include aluminum metal layers, the aluminum layer is formed over the insulating layer and then the aluminum layer is patterned through a photo process.

The material for the bottom and top electrodes 110 and 130 is not limited to copper or aluminum, but various conductive materials can be selectively used corresponding to the metal interconnection used in the semiconductor device. The capacitor according to the embodiment may be formed between metal interconnection layers. In this case, an electrode of the capacitor may include a metal interconnection. The barrier metal layers 111 and 112 may include a metal layer having a stack structure of Ti and TiN, in which Ta can be used instead of Ti.

The dielectric layer 120 includes a first dielectric layer 121, a second dielectric layer 122 and a third dielectric layer 123. The first and third dielectric layers 121 and 123 may, for example, be formed using the same material. The first and third dielectric layers 121 and 123 may include Al₂O₃. The second dielectric layer 122 may include at least one of HfO₂, ZrO₂ and Ta₂O₅.

A band gap of the first and third dielectric layers 121 and 123 may be larger than that of the second dielectric layer 122. The band gap of the second dielectric layer 122 may be, for example, approximately 5.7 eV. Characteristics of the second dielectric layer 122, such as leakage current characteristic, may be degraded if the thickness of the second dielectric layer is less than a predetermined thickness. However, since the first and third dielectric layers, which relatively greater band gaps, are formed under and over the bottom and top surfaces of the second dielectric layer 122, the leakage current characteristic and breakdown voltage characteristic can be improved.

The dielectric constant of the second dielectric layer may be greater than that of the first and third dielectric layers 121 and 123. The dielectric layer 120 may have a thickness of about 160 Å±10 Å. In more detail, the first dielectric layer 121 may have a thickness of about 30 Å±2 Å, the second dielectric layer 122 may have a thickness of about 100 Å±5 Å, and the third dielectric layer 123 may have a thickness of about 30 Å±2 Å. The capacitor having the above structure may have capacitance of about 8˜10 fF/μm².

Example FIGS. 2 to 4 are sectional views showing the manufacturing procedure for the capacitor of the semiconductor device according to embodiments. As shown in example FIG. 2, the barrier metal layer is formed over a substrate including the bottom electrode 110. The substrate may be a semiconductor substrate including an insulating layer having a copper metal interconnection, and the bottom electrode 110 may include copper. The barrier metal layer 111 prevents the copper from diffusing into adjacent layers.

The substrate may include a semiconductor substrate, which has formed over the top surface thereof an insulating layer having an aluminum metal interconnection, and the bottom electrode 110 may include aluminum. The barrier metal layer 111 can be omitted, if the bottom electrode includes aluminum.

The barrier metal layer 111 may include at least one of Ti, Ta, Ti/TiN and Ta/TaN. If the barrier metal layer 111 includes Ti/TiN, a Ti layer is formed over the bottom electrode 110 and a TiN layer is formed over the Ti layer.

As shown in example FIG. 3, the substrate having the bottom electrode 110 is loaded into ALD (Atomic Layer Deposition) equipment, so that the first to third dielectric layers 121, 122 and 123 are consecutively deposited over the bottom electrode 110. If the ALD scheme is employed, the dielectric layer 120 having a thickness of 0.8 Å can be deposited for one cycle. Thus, the dielectric layer 120 having the desired thickness can be deposited by repeating the cycles several times. The ALD process may be performed under the process temperature of about 300 to 400° C.

First, the first dielectric layer 121 may be deposited over the substrate having the bottom electrode 110. The first dielectric layer 121 may include Al₂O₃. The first dielectric layer 121 may have a thickness of about 30 Å±2 Å. The first dielectric layer 121 may be formed by allowing TMA (Tri Methyl Aluminum), which serves as a precursor, to react with ozone (O₃).

Once the first dielectric layer 121 has been deposited, the second dielectric layer 122 may be consecutively deposited over the first dielectric layer 121. The second dielectric layer 122 may include HfO₂. Further, the second dielectric layer 122 may include one of ZrO₂ and Ta₂O₅. The second dielectric layer 122 may have a thickness of about 100 Å±5 Å. The second dielectric layer 122 may be formed by allowing TEMAHf (Tetrakis[EthylMethylAmino]Hafnium), which serves as a precursor, to react with ozone (O₃).

Once the second dielectric layer 122 has been deposited, the third dielectric layer 123 may be consecutively deposited over the second dielectric layer 122. The third dielectric layer 123 may include Al₂O₃. The third dielectric layer 123 may have a thickness of about 30 Å±2 Å. The third dielectric layer 123 may be formed by allowing TMA (Tri Methyl Aluminum), which serves as a precursor, to react with ozone (O₃).

The total thickness of the first to third dielectric layers 121, 122 and 123 may be 160 Å±10 Å. Therefore, the capacitor according to embodiments may have high capacitance while reducing the thickness of the dielectric layer 120 as compared with that of the related art. For example, the capacitor having the above stack structure, material and thickness may have a capacitance of about 8˜10 fF/μm².

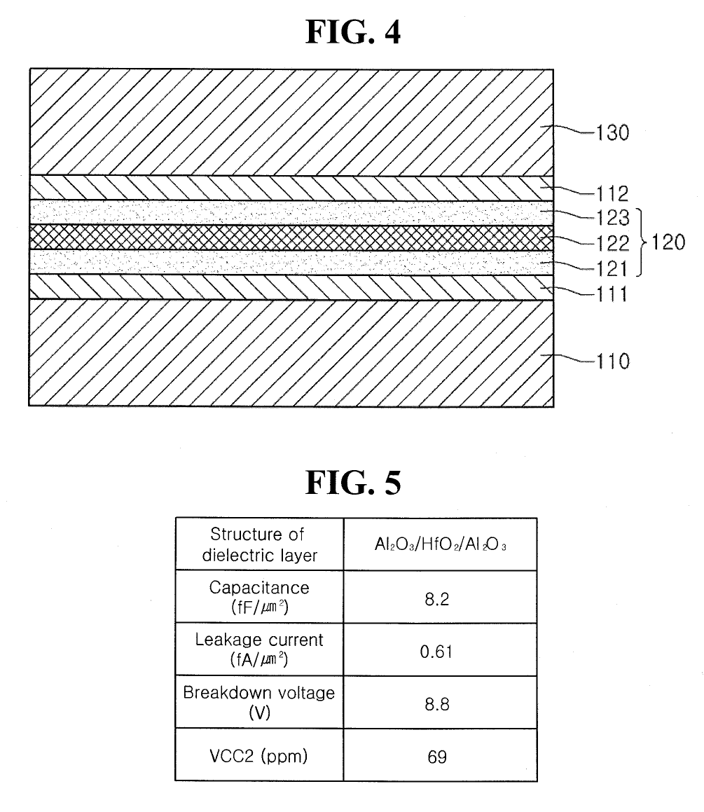

As shown in example FIG. 4, a second barrier metal layer 112 and the top electrode 130 may be consecutively formed over the dielectric layer 120. The top electrode 130 may include a copper metal layer or an aluminum metal layer. The barrier metal layer 112 may include at least one of Ti, Ta, Ti/TiN and Ta/TaN.

Since the band gap of the first and third dielectric layers 121 and 123 is greater than that of the second dielectric layer 122, the leakage current characteristic and breakdown voltage characteristic of the dielectric layer 120 can be improved. In addition, since the second dielectric layer 122 has a great dielectric constant, the dielectric layer 120 may have high capacitance.

Example FIG. 5 is a chart showing characteristic values of a capacitor according to embodiments. The first dielectric layer 121 is formed through the ALD process by using Al₂O₃ such that the first dielectric layer 121 has a thickness of about 30 Å. In addition, the second dielectric layer 122 is formed through the ALD process by using HfO₂ such that the second dielectric layer 122 has a thickness of about 100 Å. The third dielectric layer 123 is formed through the ALD process by using Al₂O₃ such that the third dielectric layer 123 has a thickness of about 30 Å. In this case, the capacitor has capacitance of about 8.2 fF/μm².

In addition, the leakage current characteristic of the capacitor is 0.61 fA/μm², which is significantly smaller than the reference leakage current value (10 fA/μm²). That is, the capacitor represents superior leakage current characteristic.

Further, the breakdown voltage is represented as 8.8V and the VCC 2 (Voltage Coefficient Current 2) curve is represented as 69 ppm, which is smaller than the reference value of 100 ppm. Therefore, in a capacitor according to embodiments, the current value variation is very small when the voltage variation is within the range of −5V to 5V, so the capacitor has superior and stable electric characteristics.

The capacitor of the semiconductor device according to the embodiment has high capacitance and superior endurance. According to the method for manufacturing the capacitor of the semiconductor device of embodiments, the dielectric layer having a shallow thickness and a high dielectric constant can be stably formed, so the process reliability and the productivity can be improved.

According to the capacitor of the semiconductor device of embodiments, dielectric layers having great band gaps are deposited over and under the top and bottom of a dielectric layer having a small band gap, so that the electric stability and leakage current characteristic can be improved. According to embodiments, a capacitor having high capacitance of 8 fF or above can be used in a semiconductor device, so the capacitor is advantageous in development of high technology DRAM and CMOS devices.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a bottom electrode over a substrate;
a dielectric stacked layer over the bottom electrode including a first dielectric layer having a first thickness, a second dielectric layer having a second thickness greater than the first thickness, and a third dielectric layer having a thickness approximately equal to the first thickness; and
a top electrode over the dielectric layer.

2. The apparatus of claim 1, wherein the second thickness is about 100 Å±5Å.

3. The apparatus of claim 1, wherein the first thickness is about 30 Å±2 Å.

4. The apparatus of claim 3, wherein the second thickness is about 100 Å±5 Å.

5. The apparatus of claim 4, wherein the first and third dielectric layers include Al₂O₃.

6. The apparatus of claim 1, wherein the first and third dielectric layers include Al₂O₃.

7. The apparatus of claim 4, wherein the second dielectric layer includes at least one of HfO₂, ZrO₂ and Ta₂O₅.

8. The apparatus of claim 1, wherein the second dielectric layer includes at least one of HfO₂, ZrO₂ and Ta₂O₅.

9. The apparatus of claim 4, wherein the bottom electrode, the dielectric stacked layer, and the top electrode form a capacitor, wherein the capacitance of the capacitor is in a range of about 8 fF/μm² to about 10 fF/μm².

10. The apparatus of claim 1, wherein the bottom electrode, the dielectric stacked layer, and the top electrode form a capacitor, wherein the capacitance of the capacitor is in a range of about 8 fF/μm² to about 10 fF/μm².

11. A method comprising:
forming a bottom electrode over a substrate;
forming a first dielectric layer having a first thickness over the bottom electrode;
forming a second dielectric layer having a second thickness greater than the first thickness over the first dielectric layer;
forming a third dielectric layer having a thickness approximately equal to the first thickness over the second dielectric layer; and
forming a top electrode over the third dielectric layer.

12. The method of claim 11, wherein the second thickness is about 100 Å±5 Å.

13. The method of claim 11, wherein the first thickness is about 30 Å±2 Å.

14. The method of claim 13, wherein the second thickness is about 100 Å±5 Å.

15. The method of claim 14, wherein the first to third dielectric layers are consecutively deposited through an atomic layer deposition process.

16. The method of claim 11, wherein the first to third dielectric layers are consecutively deposited through an atomic layer deposition process.

17. The method of claim 14, wherein the first to third dielectric layers are formed by depositing Al₂O₃ using tri-methyl-aluminum and ozone.

18. The method of claim 11, wherein the first to third dielectric layers are formed by depositing Al₂O₃ using tri-methyl-aluminum and ozone.

19. The method of claim 12, wherein the second dielectric layer is formed by depositing HfO₂ using tetrakis[ethylmethylamino]hafnium and ozone.

20. The method of claim 14, wherein the first to third dielectric layers are formed under a process temperature of about 300° C. to 400° C.
